(19) United States
(12) Patent Application Publication
(10) Pub. No.: US 2009/0217219 A1
(43) Pub. Date: Aug. 27, 2009

(54) Method for designing an integrated circuit

(75) Inventors: Stefan Defregger, Lieboch (AT); Gerhard Rappitsch, Lieboch (AT)

Correspondence Address: COHEN, PONTANI, LIEBERMAN & PAVANE LLP, 551 FIFTH AVENUE, SUITE 1210, NEW YORK, NY, 10176, US

(73) Assignee: austriamicrosystems AG, A-8141 Unterpremstatten (AU)

(21) Appl. No.: 11/886,013

(22) PCT Filed: Mar. 7, 2006
(86) PCT No.: PCT/EP2006/002089

§ 371 Date: Dec. 29, 2008

(30) Foreign Application Priority Data
Mar. 10, 2005 (DE) 10 2005 011 150.5

(51) Int. Cl. G06F 17/50

(52) U.S. Cl. 716/4

(57) ABSTRACT

A method for designing an integrated circuit is specified, in which upper and lower limits of dependent component parameters and of environment parameters (3, 4) are determined. The limits of the dependent component parameters are determined in a manner dependent on limits of component fabrication parameters in a worst-case consideration. The dependent component parameters and environment parameters are subsequently first normalized (5) with regard to their limits before experimental designs are constructed and simulations are carried out (6, 7). An analysis of the results (8) yields not only qualitative but also quantitative statements about dependencies of result variables, for example, the bandwidth of a circuit, on principal effects, for example, the drain current of a transistor or the capacitance value of a capacitor component.

The present invention relates to a method for designing an integrated circuit.

Particularly when designing analog integrated circuits, taking account of the influence of fluctuations of the fabrication parameters such as, for example, the length of a channel of a transistor of the unipolar type is of importance. Fluctuations of environment parameters such as temperature or supply voltage also play a major part. These parameters greatly influence the electrical properties of an integrated circuit, such as, for example, the bandwidth of an operational amplifier. Therefore, it is desirable, as early as at the design stage, to make estimations of whether or not the circuit will meet the requirements, which are defined in a specification, for example, for given tolerance ranges of fabrication parameters and environment parameters.

Circuit simulation tools are available as software for this purpose, which tools are based on a corner analysis and can simulate combinations of different worst-case conditions. As the result of a simulation and analysis by means of such known software tools, the latter normally give an answer as to whether or not the designed circuit complies with predetermined limits with its electrical properties. Data sheets are generated which specify the variation of a specific design parameter over the range of the simulated corners.

Furthermore, statistical analysis tools are known in which so-called orthogonal design of experiments, DOE that is to say experimental designs, are used. With these, worst-case models are generated for individual components, for example, for a metal oxide semiconductor, MOS transistor. Said models are based on previous principal component analyses of SPICE parameters. However, the experimental designs proposed in such statistical analysis tools relate in each case to only an individual electronic component such as a transistor, resistor, etc.

The document U.S. Pat. No. 6,381,564 B1 specifies a DOE with subsequent RSM modeling. Favorable conditions of parameters for TCAD simulators are thereby obtained.

For the circuit developer it would be desirable however, for a functional block of the circuit that comprises a plurality of semiconductor components, to yield results that allow conclusions to be drawn about principal effects and interactions. It would thus be desirable if, by way of example, a statement could be made about which parameter has the greatest influence for the bandwidth of an operational amplifier, for example, the variation of the channel length of the p-channel MOS transistors involved, the supply voltage or the like. The circuit developer would thereby be given valuable indications as to how the design is to be adapted in order to be able to comply with predetermined specifications.

It is an object of the present invention to specify a method for designing an integrated circuit which, for given tolerances in an integrated fabrication method for an experimental design, can yield results about which component and environment parameters have the principal influence on a specific property of a functional block of the experimental design.

The object is achieved according to the invention by means of a method for designing an integrated circuit comprising the steps of:
selecting a plurality of component parameters of the integrated circuit and determining respective upper and lower tolerance limits of the component parameters, for a given fabrication method,
defining at least one dependent component parameter in a manner dependent on in each case a plurality of the component parameters determined,
determining the upper and lower limits of the at least one dependent component parameter in a manner dependent on the upper and lower tolerance limits of the respective component parameters in a worst-case consideration,
defining an upper limit and a lower limit of at least one environment parameter,
normalizing the upper limit of the at least one dependent component parameter, the lower limit of the at least one dependent component parameter, the upper limit of the at least one environment parameter and the lower limit of the at least one environment parameter,
constructing experimental designs of the integrated circuit on the basis of the normalized upper and lower limits of the at least one component parameter and of the at least one environment parameter,
carrying out simulations of the experimental designs,
analyzing the results of the simulations of the experimental designs of the integrated circuit with regard to the influence of the at least one dependent component parameter and the at least one environment parameter.

The construction of specific experimental designs for semiconductor fabrication processes with subsequent circuit simulation is proposed according to the principle proposed. This involves determining properties of the circuit of the experimental design depending on fluctuations of fabrication parameters of components and of environment parameters in respectively predetermined limits.

A systematic improvement of the yield in analog circuit design is obtained by means of the proposed invention. A so-called robust design is made possible. Special experimental designs are constructed in order to determine the principal effects that determine the variation of the performance of analog circuit designs by means of circuit simulation. Said principal effects are defined by so-called component categories, which are referred to as dependent component parameters in the present case. Preferably, a respective one of said dependent component parameters is defined for a respective semiconductor component used, that is to say for resistors, capacitors, transistors of the n-channel type, transistors of the p-channel type, bipolar transistors, high-voltage transistors for each conductivity type. This category also includes environment parameters such as supply voltage, junction temperature etc.

Each of these factors, namely dependent component parameters and environment parameters, varies within predetermined minimum and maximum values in a manner dependent on the predetermined variations of a specific fabrication process and the specifications of the design. Thus, by way of example, the temperature varies between a minimum temperature and a maximum temperature, and the dependent fabrication parameter of the n-channel MOS transistor varies between a low switching speed and a high switching speed.

Specific experimental designs are generated in a manner dependent on the number of components used, the number of dependent component parameters and the number of environment parameters, said experimental designs being simulated by means of a circuit simulation.

The results of the simulation can be analyzed by means of statistical methods in order to determine the principal effects that are crucial for a specific property of the circuit of the experimental design. The statistical methods can also be used to determine the interactions between the individual factors, namely dependent component parameters and environment parameters. The rank order of the influence of the dependent component parameters and environment parameters can be calculated by means of so-called Pareto methods, for example.

The determination of these principal factors enables the circuit developer to concentrate on these principal effects in order to reduce the variation of the property of the simulated circuit and thus to increase the yield for this circuit design. Consequently, it is possible to create a particularly robust circuit design.

What is more, the interactions of the individual dependent component parameters and environment parameters can be analyzed. This interaction analysis makes it possible to determine the influence of a specific factor, that is to say dependent component parameter or environment parameter, on another factor, that is to say another environment variable or dependent component parameter. Thus, by way of example, it is possible to determine the sensitivity of a property of the circuit with regard to the switching speed of an n-channel field effect transistor depending on the variation of a resistance value.

This combined analysis of principal effects and interactions in turn puts the circuit developer in a position to reduce the circuit sensitivity in a systematic manner.

As an alternative or in addition, an automated optimization loop can also be carried out on the basis of response surface modeling, RSM modeling, in order to obtain optimum design parameters that reduce the variation of the circuit properties and increase the yield.

According to the principle proposed, the experimental designs of the integrated circuit are accordingly not determined in a manner dependent on the actual component parameters such as channel length, sheet resistance, substrate doping, etc., but rather as a function of dependent component parameters such as resistance value of a resistor, capacitance value of a capacitor, saturation current of an n-channel MOS transistor and also in a manner dependent on environment parameters such as supply voltage and temperature. In this case, the upper and lower limits of the dependent fabrication parameters and of the environment parameters are normalized in terms of their upper and lower limits before the construction of the experimental designs.

Preferably, an optimization loop based on RSM modeling is carried out in order to determine optimum design parameters with which the variation of the properties of the integrated circuit can be reduced and the yield can be improved.

The subclaims relate to further details and advantageous developments of the principle proposed.

The invention is explained in more detail below on the basis of a plurality of exemplary embodiments with reference to drawings, in which:

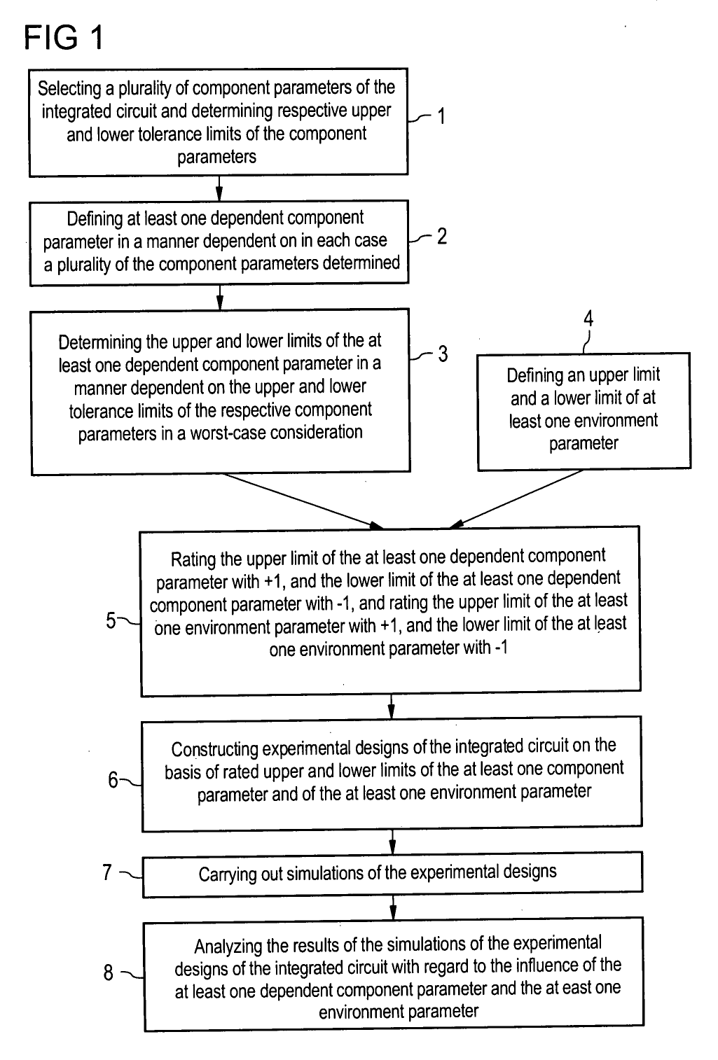

FIG. 1 shows an exemplary flowchart of a method according to the principle proposed,

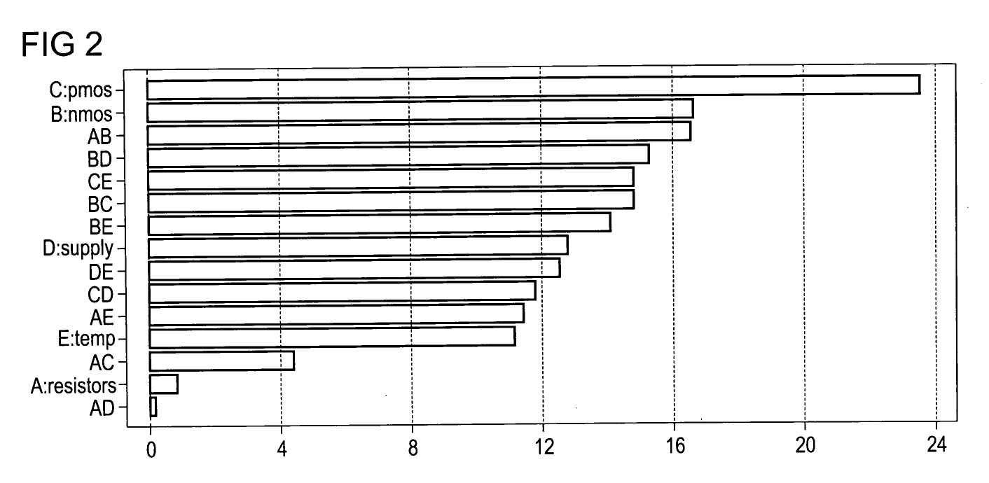

FIG. 2 shows a statistical analysis of principal effects and interactions for an experimental design of an operational amplifier on the basis of an exemplary diagram,

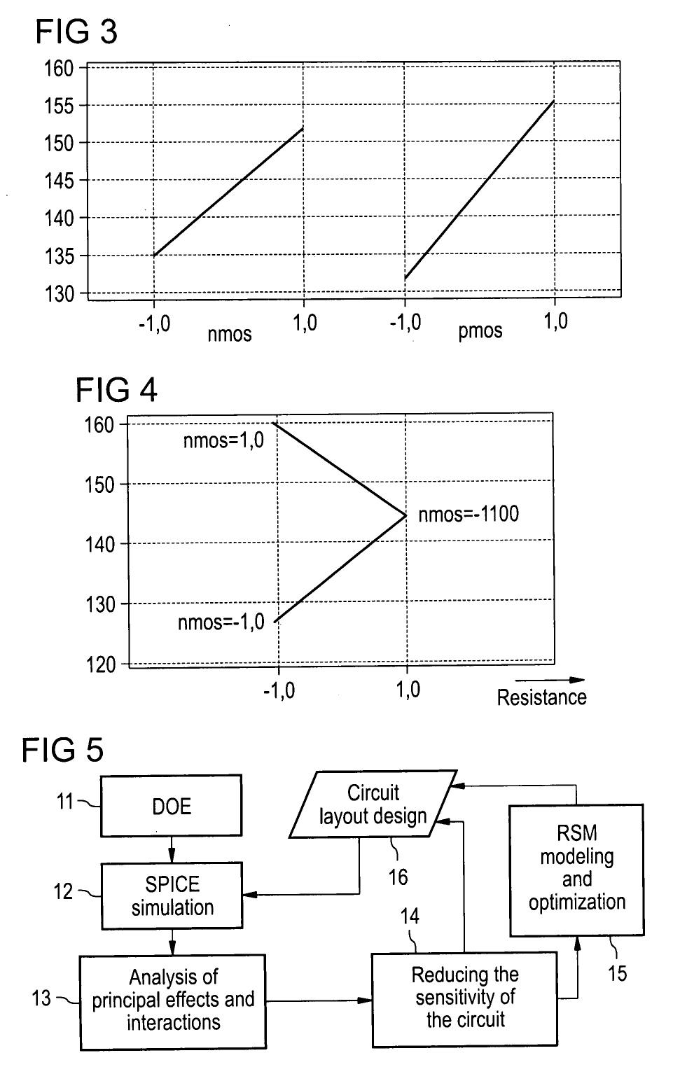

FIG. 3 shows a graphical representation of the principal effects of the bandwidth of an operational amplifier,

FIG. 4 shows a graphical representation of interactions of the factors resistance and NMOS transistor saturation current for the bandwidth of the operational amplifier on the basis of an example, and

FIG. 5 shows a further exemplary flowchart.

FIG. 1 shows a flowchart of an exemplary method for designing an integrated circuit according to the principle proposed. In this case, a plurality of component parameters of the integrated circuit are selected in a first step 1. This involves determining the tolerance limits within which said component parameters can vary for a given fabrication method.

At least one dependent component parameter is defined in a subsequent step 2. In this case, the dependent component parameter is dependent on at least two of the fabrication parameters determined in the first step 1.

A dependent component parameter is, for example, the saturation drain current of a metal oxide semiconductor, MOS transistor, in each case separately for the n-channel transistor and the p-channel transistor. Further dependent component parameters are the saturation drain current of a high-voltage n-channel transistor and of a high-voltage p-channel MOS transistor. The resistance value of an integrated resistor, the capacitance value of an integrated capacitor and the switching speed of a bipolar transistor are also dependent component parameters in accordance with step 2.

In this case, a high-voltage transistor is understood to be an integrated transistor that is designed for higher voltages than usual in a standard MOS process.

The upper and lower limit of the at least one dependent component parameter is determined in a subsequent, third step 3. This determination is effected in a manner dependent on the upper and lower tolerance limits of the respective component parameters on which the at least one dependent component parameter is dependent. A worst-case estimation is performed in this case. The determination of the maximum and minimum values, that is to say upper and lower limits, of a dependent component parameter will be explained below using the example of the saturation current of a MOS transistor. In this case, the so-called worst-case-power condition is met given maximum saturation current, while the worst-case-speed condition is met given minimum saturation current. Here, worst-case power means that the transistor has the maximum power consumption, while in the worst-case-speed case the transistor has the lowest switching speed.

The upper and lower limit of the saturation current is obtained by constructing parameter vectors that describe the transistor behavior. For MOS transistors, such parameter vectors comprise the following parameters: the threshold voltage vth0, the variation of the channel length x1, the oxide thickness tox, the variation of the channel width xw, the mobility of the charge carriers μ0, the substrate doping nsub, the channel doping nch and the sheet resistance rsh. Each of said parameters varies within permitted limits in a predetermined semiconductor fabrication process. In order to determine the maximum and minimum saturation current of the transistor, the component parameters enumerated are set to their permitted minimum or maximum values, as described in table 1 below.

TABLE 1

| | worst case power | worst case speed |
|---|---|---|
| SPICE parameter | (“+1”) | (“−1”) |
| vth0 | min | max |
| x1 | min | max |
| tox | min | max |
| μ0 | max | min |
| nsub | min | max |
| nch | min | max |
| rsh | min | max |
| xw | max | min |

The same method is also applied in order to determine the worst-case-power condition and the worst-case-speed condition for high-voltage transistors. These steps are performed for normal and for high-voltage transistors in each case separately for transistors of the n-channel type and of the p-channel type.

After the determination of the upper and lower limit of the dependent component parameter of the transistor, as described above, a normalization of said upper and lower limit is effected in a subsequent step 5. This normalization will be explained in more detail later.

As for the transistors of the field effect type, an upper limit and a lower limit of the resistance value are determined for the integrated resistors, too. In this case, the lowest possible resistance value corresponds to the worst-case-power condition, and the maximum resistance value corresponds to the worst-case-speed condition. The resistance values are determined, as described above, from a parameter vector by varying the independent component parameters within the limits permitted for them. The parameter vector for resistors comprises the following parameters: sheet resistance rsh and width wd. This results in table 2 below.

TABLE 2

| | worst case power | worst case speed |
|---|---|---|
| SPICE parameter | (“+1”) | (“−1”) |
| rsh | min | max |
| wd | min | max |

The determination according to step 3 is carried out for integrated capacitors, too. In this case, the lower limit of the capacitance value corresponds to the worst-case-power condition and the upper limit of the permitted capacitance value corresponds to the worst-case-speed condition. The capacitance values, in particular the upper and lower limits are then determined from a parameter vector of the capacitor by varying the independent component parameters within permitted limits. The parameter vector for capacitors is dependent on the following independent parameters: specific capacitance per area ca and specific capacitance per periphery cp. This is illustrated below on the basis of table 3.

TABLE 3

| | worst case power | worst case speed |
|---|---|---|
| SPICE parameter | (“+1”) | (“−1”) |
| ca | min | max |
| cp | min | max |

Upper and lower limits of a dependent component parameter are defined for bipolar transistors, too. The upper and lower limits with regard to the switching speed are in turn determined from a parameter vector of the bipolar transistor by varying the independent component parameters within permitted limits. The parameter vector for bipolar transistors is dependent on the following independent parameters: current gain bf, saturation current is and base resistance rb. The worst-case conditions are determined according to the scheme in accordance with table 4 below:

TABLE 4

| | high speed | low speed |
|---|---|---|
| SPICE parameter | (“+1”) | (“−1”) |
| bf | max | min |
| rb | min | max |
| is | max | min |

In addition to upper and lower limits of the dependent component parameters according to step 3, upper and lower limits of environment parameters such as temperature and supply voltage are defined in a step 4. Step 4 can be carried out independently of steps 1 to 3. In this case, the minimum and maximum temperature values correspond to the temperature range permitted in the respective application, for example, a lower limit of 0° C. and an upper limit of 85° C. The situation is likewise the same with the supply voltage. An upper limit and a lower limit of the environment parameter supply voltage correspond to the supply voltage range permitted in the application, for example, a lower limit of the supply voltage of 3.0 V and an upper limit of the supply voltage of 3.6 V. The conditions are elucidated in tables 5 and 6 below.

TABLE 5

| (“+1”) | (“−1”) |
|---|---|
| maximum temperature | minimum temperature |

TABLE 6

| (“+1”) | (“−1”) |
|---|---|
| maximum supply voltage | minimum supply voltage |

After the determination of the upper and lower limit of the dependent component parameters in step 3 and of the environment parameters in step 4, they are in each case normalized in a subsequent step 5. This involves rating the upper limits of the dependent component parameters and of the environment parameters with +1 and also rating the lower limits of the dependent component parameters and of the environment parameters with −1. This normalization and rating is in each case performed such that the maximum performance of the worst-case conditions determined corresponds to the value +1, while the minimum performance corresponds to the value −1 for the resulting experimental design. Tables 1 to 6 represented above in each case reproduce the relationship between the normalization and the dependent component parameter or environment parameter.

After this normalization, a construction of experimental designs is performed in a sixth step 6. Experimental designs are usually referred to as design of experiment, DOE. The experimental designs serve for circuit simulation by means of a conventional simulator, such as SPICE for example. In this case, the DOE are formed either in full-factorial fashion or in half-factorial fashion or in a manner reduced still further. Full-factorial construction of the experimental designs results in a full-factorial design 2ⁿ while 2ⁿ⁻¹ holds true for a half-factorial design. In this case, the exponent n is equal to the sum of the number of dependent component parameters m and the number 2. In this case, the number 2 denotes the sum of the environment variable temperature and the environment parameter supply voltage. If fewer or more environment parameters are used, then the number is to be adapted accordingly.

The DOE is composed of worst-case SPICE models for specific component groups. Here, a worst-case SPICE model is defined as a specific vector of SPICE parameters, for example, threshold voltage, charge carrier mobility etc., which reproduce an extreme condition of the electrical properties of the component, for example, a maximum saturation current in a MOS transistor.

Afterward, on the basis of an example for the order n equals 5, a half-factorial DOE 2⁵⁻¹ is constructed for the circuit simulation. Three dependent parameters and two environment parameters are provided, that is to say a total of five factors. The resistance value of the resistor, the saturation current of the NMOS transistor and the saturation current of the PMOS transistor were provided as dependent parameters. Supply voltage and temperature were defined as environment parameters. Table 7 shows this exemplary DOE according to the stipulations specified in accordance with tables 1 to 6. The DOE in half-factorial representation reduces the total number of simulations and hence simulation time by a factor 2 in relation to full-factorial design. For reference in subsequent representations, the five factors have been designated by the letters A, B, C, D, E, as specified in table 7.

TABLE 7

| | | | | Supp. | |
|---|---|---|---|---|---|
| | Resistor | NMOS | PMOS | volt. | Temp. |
| Pass | A | B | C | D | E |
| 1 | −1 | −1 | −1 | −1 | 1 |
| 2 | 1 | −1 | −1 | −1 | −1 |
| 3 | −1 | 1 | −1 | −1 | −1 |
| 4 | 1 | 1 | −1 | −1 | 1 |
| 5 | −1 | −1 | 1 | −1 | −1 |
| 6 | 1 | −1 | 1 | −1 | 1 |
| 7 | −1 | 1 | 1 | −1 | 1 |
| 8 | 1 | 1 | 1 | −1 | −1 |
| 9 | −1 | −1 | −1 | 1 | −1 |
| 10 | 1 | −1 | −1 | 1 | 1 |
| 11 | −1 | 1 | −1 | 1 | 1 |
| 12 | 1 | 1 | −1 | 1 | −1 |
| 13 | −1 | −1 | 1 | 1 | 1 |
| 14 | 1 | −1 | 1 | 1 | −1 |
| 15 | −1 | 1 | 1 | 1 | −1 |
| 16 | 1 | 1 | 1 | 1 | 1 |

According to the principle proposed, it is advantageous to define corresponding DOE beforehand in a manner dependent on the factors in a special circuit design, which have been described above as dependent component parameters and environment parameters.

The experimental designs according to the principle proposed are accordingly advantageously predefined and depend only on the number of factors, not on the special design chosen. Particularly easy integration into a design environment is thus possible. In the present example, given a number of m different components for which a respective dependent component parameter is defined, n=m+2 factors are taken into account, namely the number of components m plus supply voltage plus temperature. The examples below demonstrate the generation of specific DOE for specific types of circuits in low-voltage and high-voltage CMOS fabrication processes.

The following half-factorial DOE are predefined and constructed for low-voltage CMOS processes:

DOE_{—}8 (2⁴⁻¹): NMOS, PMOS, temperature, supply voltage

DOE_{—}16 (2⁵⁻¹): NMOS, PMOS, resistor, temperature, supply voltage

DOE_{—}32 (2⁶⁻¹): NMOS, PMOS, resistor, capacitor, temperature, supply voltage

DOE_{—}64 (2⁷⁻¹): NMOS, PMOS, resistor, capacitor, bipolar transistor, temperature, supply voltage.

The following half-factorial DOE are predefined and constructed for high-voltage CMOS processes:

DOE_{—}8 (2⁴⁻¹): HVNMOS, HVPMOS, temperature, supply voltage

DOE_{—}16 (2⁵⁻¹): HVNMOS, HVPMOS, resistor, temperature, supply voltage

DOE_{—}32HV (2⁶⁻¹): NMOS, PMOS, HVNMOS, HVPMOS, temperature, supply voltage

DOE_{—}64HV (2⁷⁻¹): NMOS, PMOS, HVNMOS, HVPMOS, resistor, temperature, supply voltage.

DOE_{—}128HV (2⁸⁻¹): NMOS, PMOS, HVNMOS, HVPMOS, resistor, capacitor, temperature, supply voltage.

The differentiation of the component categories high-voltage transistor and normal transistor enables a separate investigation of the circuit sensitivities.

The constructing of experimental designs in step 6 is followed by carrying out simulations of the experimental designs in a further step 7 and subsequently by an analysis of the results of the simulation of the experimental designs in a step 8. During the analysis of the results, the experimental design is investigated with regard to the influence of the at least one dependent component parameter and the at least one environment parameter. The investigation of interactions is additionally possible.

Response variables that characterize the electrical properties of the circuit are defined depending on the respective application. These are designated by R1, R2 to Rn in the present case. The value of said response variables is defined by the circuit simulation for each pass of the DOE. The number of passes corresponds to the number 2ⁿ in the case of a full-factorial design and 2ⁿ⁻¹ in the case of a half-factorial design.

For integration into a computer-aided design, CAD environment, the experimental designs generated are translated into a file with regard to a corner vector definition which is compatible with the existing software environment. By way of example, a DCF format can be generated. A file generated in this way can be loaded directly into a known corner analysis simulation tool. The following text shows by way of example the definition of the corner model No. 1 in the DCF format.

corAddDesignVar(“Vsupply”)
corAddCorner(“C35B4”“corner1”)
corSetCornerGroupVariant(“C35B4”“corner1”“cmos53.scs”“cmosws”)
corSetCornerGroupVariant(“C35B4”“corner1”“res.scs”“resws”)
corSetCornerRunTempVal(“C35B4”“corner1”85)
corSetCornerVarVal(“C35B4”“corner1”“Vsupply”“3.0”)

On the basis of the example of an operational amplifier integrated using CMOS circuit technology, the following response variables are defined, which are designated by R1 to R5 in table 9 below: the open loop gain AO, the bandwidth BW, the equivalent input noise EIVN and the total harmonic distortion THD. A circuit simulation is subsequently carried out for all 16 passes. The values of the response variables are calculated from the simulation results. Table 9 below compiles the simulated results for all 16 passes of the simulation:

TABLE 9

| | | | EIVN | | |
|---|---|---|---|---|---|
| | | | [nV/sqrt | | |
| Run | A0 [dB] | BW [MHz] | (Hz)] | PM [deg.] | THD[dBc] |
| No. | R1 | R2 | R3 | R4 | R5 |
| 1 | 97.3576 | 106.321 | 22.9874 | 70.3483 | −59.9667 |
| 2 | 98.2232 | 97.6666 | 22.8982 | 58.0436 | −86.9425 |
| 3 | 95.2257 | 141.915 | 22.5935 | 76.7319 | −85.5839 |
| 4 | 96.9762 | 132.602 | 18.7647 | 67.2115 | −77.9551 |
| 5 | 96.6942 | 133.935 | 20.3635 | 68.6819 | −123.534 |
| 6 | 97.0835 | 147.551 | 16.905 | 60.3783 | −104.003 |
| 7 | 96.2685 | 165.571 | 16.7094 | 78.1484 | −106.408 |
| 8 | 94.6684 | 173.124 | 20.1139 | 61.3255 | −119.77 |
| 9 | 97.6545 | 116.957 | 19.0935 | 60.8845 | −31.1581 |
| 10 | 96.2365 | 143.866 | 18.8465 | 80.4307 | −31.1691 |
| 11 | 94.5591 | 152.228 | 22.6789 | 62.9144 | −58.7781 |
| 12 | 96.0629 | 163.828 | 16.9903 | 71.3962 | −69.4082 |
| 13 | 95.6935 | 149.717 | 20.4539 | 55.8466 | −80.0875 |
| 14 | 93.8689 | 187.088 | 20.1939 | 74.551 | −79.3863 |
| 15 | 95.4121 | 179.936 | 16.7886 | 66.4539 | −69.5818 |
| 16 | 98.5541 | 107.208 | 19.0021 | 74.0273 | −78.062 |

Principal effects and interactions are determined during the result analysis in step 8, as explained below on the basis of the example. The principal effects can be determined by means of a statistical sensitivity analysis of the simulated results, as can interactions between the dependent component parameters and the environment parameters. It is thereby possible to establish the causality of the result with a specific variable, and also to form a correlation between a result variable and a specific dependent component parameter or environment parameter. This information is of great importance for the circuit developer in order to reduce the circuit sensitivity with regard to process fluctuations. What is more, the information about principal effects is important during production for the process engineer in order to be able to carry out an efficient process control of the critical variables and parameters.

Principal effects can be calculated for each result variable. For a predetermined result variable R, the influence of a factor x is calculated in accordance with the specification:

cₓ=M_{R}(+)−M_{R}(−).

In this case, the factor x is from the set of dependent component parameters and environment parameters. M_{R}(+) represents the mean value of the result variables for all experiments where the factor x=1. M_{R}(−) represents the mean value of all the result variables for all experiments in which x=−1.

In order to determine for example the effect of the dependent component parameter x=PMOS, that is to say factor c in table 10, on the result variable R2=BB, bandwidth, that is to say R2 in table 9, the mean value of the results for the bandwidth with the factor PMOS at +1 is calculated by

$${M}_{R} ( + ) = \frac{\begin{matrix}133.935 + 147.551 + 173.124 + \\ 149.717 + 187.088 + 179.936 + 107.208\end{matrix}}{8}$$

The mean value of the results for the bandwidth with the factor PMOS at −1 is calculated according to the equation

$${M}_{R} ( - ) = \frac{\begin{matrix}106.321 + 97.6666 + 141.915 + 132.602 + \\ 116.957 + 143.866 + 152.228 + 163.828\end{matrix}}{8}$$

Consequently, the principal effect of the factor PMOS on the bandwidth is estimated according to the specification

c₀=M_{R}(+)−M_{R}(−)=23.5933.

All principal effects are calculated in this way.

The second-order interactions are calculated in an analogous manner. These are designated by the symbols AB, AC, AD, AE, BC, BD, BE, CD, CE, DE. Table 10 shows in the right-hand column, by way of example, the relations of the interaction AB between resistor and NMOS.

TABLE 10

| | | | | Supp. | | Resistor × |
|---|---|---|---|---|---|---|
| | Resistor | NMOS | PMOS | volt. | Temp. | NMOS |
| Pass | A | B | C | D | E | AB |
| 1 | −1 | −1 | −1 | −1 | 1 | 1 |
| 2 | 1 | −1 | −1 | −1 | −1 | −1 |
| 3 | −1 | 1 | −1 | −1 | −1 | −1 |
| 4 | 1 | 1 | −1 | −1 | 1 | 1 |
| 5 | −1 | −1 | 1 | −1 | −1 | 1 |
| 6 | 1 | −1 | 1 | −1 | 1 | −1 |
| 7 | −1 | 1 | 1 | −1 | 1 | −1 |
| 8 | 1 | 1 | 1 | −1 | −1 | 1 |
| 9 | −1 | −1 | −1 | 1 | −1 | 1 |
| 10 | 1 | −1 | −1 | 1 | 1 | −1 |
| 11 | −1 | 1 | −1 | 1 | 1 | −1 |
| 12 | 1 | 1 | −1 | 1 | −1 | 1 |
| 13 | −1 | −1 | 1 | 1 | 1 | 1 |
| 14 | 1 | −1 | 1 | 1 | −1 | −1 |
| 15 | −1 | 1 | 1 | 1 | −1 | −1 |
| 16 | 1 | 1 | 1 | 1 | 1 | 1 |

For the mixed factor AB, by way of example, M_{R}(+) is the mean value of those values for which the product AB=factor A*factor B from table 10=+1. Conversely, M_{R}(−) is the mean value of the values for which the product AB=−1. The resulting effect of the interaction AB, namely NMOS and resistor, is calculated as

c_{AB}=M_{R}(+)−M_{R}(−)=16.51

Table 11 below shows an overview of all the principal effects and interactions with regard to the bandwidth of the experimental design proposed.

A so-called response surface model RSM, can be developed from the calculation of the principal effects. If it is assumed that the factors are designated by the letters A to E in accordance with the representation above, the interactions are designated by the factors AB to DE and the coefficients are designated by C_{A}, C_{B}, . . . , C_{AB} . . . , then it is possible to construct an RSM model for the result variable R according to the following formula

$$R = {M}_{R} + \frac{{C}_{A}}{2} A + \frac{{C}_{B}}{2} B + … + \frac{{C}_{AB}}{2} AB + \frac{{C}_{AC}}{2} AC + … + ɛ$$

In this case, E is an error term and M_{R} is the large mean value of the result variables R, namely the mean value of R over all the experiments.

A graphical representation of the contributions of all the principal effects and interactions of a specific result variable can be generated in a clear way. For this purpose, FIG. 2 shows a so-called Pareto chart. In this case, the influence of the principal effects A to E and of the interactions in accordance with the above symbolism is specified for the bandwidth normalized to values from 0 to 24. It is immediately evident that the dependent component parameters NMOS transistor and PMOS transistor, that is to say the saturation current thereof, were determined as factors having the greatest influence on the variation of the bandwidth.

A graphical representation of the influence of the factors NMOS and PMOS on the bandwidth is shown in the principal effect illustration of FIG. 3. The associated result table for the bandwidth is shown by table 11 below:

TABLE 11

| | |
|---|---|
| Average = | 143.72 |
| A: Resistor = | 0.7942 |
| B: NMOS = | 16.6638 |
| C: PMOS = | 23.5933 |
| D: Supply voltage = | 12.7678 |
| E: Temperature = | −11.1732 |
| AB = | −16.5162 |
| AC = | −4.3412 |
| AD = | −0.0062 |
| AE = | −11.4467 |
| BC = | −14.7768 |
| BD = | −15.2708 |
| BE = | −14.1253 |
| CD = | −11.8258 |
| CE = | −14.8358 |
| DE = | −12.5243 |

The mixed terms, for example, AB, BD, designate interactions between different factors, namely dependent component parameters and environment parameters. Since the interaction AB, that is to say NMOS transistor with resistor, is also of not inconsiderable importance for the variation of the bandwidth, the principal effect of NMOS is advantageously determined with regard to this specific interaction.

For this purpose, a graphical representation of the interaction between the factor resistor and the factor NMOS, that is to say the factors A and B, in accordance with table 10 is specified in FIG. 4. FIG. 4 shows this interaction. The analysis of interactions between different parameters is of great importance because it makes it possible to analyze how the value of one factor influences the result variable in a manner dependent on the value of another variable. Consequently, by way of example, a great variation of a specific result variable can be systematically reduced by bringing another parameter to a specific value. Consequently, the sensitivity of the result variables can be significantly reduced by a specific factor.

The interaction between principal effects can be analyzed by means of so-called interaction plots. This graphical representation shows the result variable, for example, bandwidth, as a function of one factor, for example, of the dependent component parameter resistor, in a manner dependent on the value of another factor, for example, the dependent component parameter NMOS drain current.

The graph according to FIG. 4 shows a great interaction between the two factors and demonstrates that it is possible to significantly reduce the sensitivity of the bandwidth with regard to the variation of the NMOS transistor by using a lower resistance value. Consequently, these interaction plots enable the circuit developer to find points having lower sensitivity in a systematic manner. This is done by altering specific design parameters in the circuit. What is more, during the fabrication of the integrated circuit in the fabrication plant, the process engineer can also alter the resistance value within permitted limits in order to reduce the variation of the bandwidth and thus increase the yield. The optimization of the circuit on the basis of the results determined can also be effected in an automated manner.

FIG. 5 shows on the basis of a further flowchart, an example of a method for improving the yield during the production of an integrated circuit according to the principal proposed. A first step 11 involves constructing the DOE in accordance with steps 1 to 6, as already explained with reference to FIG. 1. This is followed, in step 12, by carrying out simulations of the experimental designs with a simulation environment. The simulation results are analyzed in subsequent step 13, in which principal effects and interactions are determined, as already explained comprehensively above.

In a manner dependent on the results of the simulation, in step 14, the sensitivity of the circuit is reduced by reducing the influence of dependent component parameters which, according to the analysis in step 13, have the greatest influence on the circuit performance, for example, on the bandwidth of an operational amplifier, by altering circuit parameters. With knowledge of these results, in step 16 the modified circuit design is effected, which leads, in turn, to a simulation in accordance with step 12. The number of optimization loops depends on the desired result. An iterative optimization of the circuit design is therefore effected. An RSM modeling and optimization 15 can optionally be effected between step 14 and step 16.

### LIST OF REFERENCE SYMBOLS

1 Selecting component parameters
2 Defining dependent component parameters
3 Determining the upper and lower limits of the dependent component parameter
4 Defining an upper and lower limit of an environment parameter
5 Normalizing the upper and lower limits
6 Constructing experimental designs
7 Carrying out simulations and determining result variables
8 Analyzing the results of the simulations
11 Construction of experimental designs
12 Simulation
13 Determining principal effects and interactions
14 Reducing the circuit sensitivity
15 Modeling and optimization, RSM
16 Circuit design

1. A method for designing an integrated circuit comprising the steps of:
selecting a plurality of component fabrication parameters of the integrated circuit and determining respective upper and lower tolerance limits of the component fabrication parameters, for a given fabrication method;
defining at least one dependent component parameter in a manner dependent on, in each case, a plurality of the component fabrication parameters determined;
determining the upper and lower limits of the at least one dependent component parameter in a manner dependent on the upper and lower tolerance limits of the respective component fabrication parameters in a worst-case consideration;
defining an upper limit and a lower limit of at least one environment parameter;
normalizing the upper limit of the at least one dependent component parameter, the lower limit of the at least one dependent component parameter, the upper limit of the at least one environment parameter and the lower limit of the at least one environment parameter;
constructing experimental designs of the integrated circuit on the basis of the normalized upper and lower limits of the at least one dependent component parameter and of the at least one environment parameter;
carrying out simulations of the experimental designs; and
analyzing the results of the simulations of the experimental designs of the integrated circuit with regard to the influence of the at least one dependent component parameter and the at least one environment parameter.

2. The method as claimed in claim 1,
wherein
one of the following component fabrication parameters is chosen as the at least one of the plurality of component fabrication parameters: threshold voltage of a transistor, channel length of a transistor, oxide thickness of a transistor, channel width of a transistor, mobility of the charge carriers in a transistor, doping of the substrate, doping of the channel of a transistor, sheet resistance of a transistor, sheet resistance of a resistor, width of a resistor, specific capacitance per area of a capacitor, specific capacitance per periphery of a capacitor, current gain of a bipolar transistor, base resistance of a bipolar transistor, saturation current of a bipolar transistor.

3. The method as claimed in claim 1,
wherein
the environment temperature and/or a supply voltage is chosen as the at least one environment parameter.

4. The method as claimed in claim 1,
wherein
the saturation current of an N-channel field effect transistor, the saturation current of a P-channel field effect transistor, the saturation current of an N-channel high-voltage transistor, the saturation current of a P-channel high-voltage transistor, the resistance value of a resistor, the capacitance value of a capacitor and/or the switching speed of a bipolar transistor is chosen as the at least one dependent component parameter.

5. The method as claimed in claim 1,
wherein
the upper and lower limits of the dependent component parameter saturation current are determined in a manner dependent on a plurality of the following component fabrication parameters: threshold voltage of a transistor, channel length of a transistor, oxide thickness of a transistor, channel width of a transistor, mobility of the charge carriers in a transistor, doping of the substrate, doping of the channel of a transistor, sheet resistance of a transistor.

6. The method as claimed in claim 1,
wherein
the upper and lower limits of the dependent component parameter resistance value of a resistor are determined in a manner dependent on the following component fabrication parameters: sheet resistance of a resistor, width of a resistor.

7. The method as claimed in claim 1,
wherein
the upper and lower limits of the dependent component parameter capacitance value of a capacitor are determined in a manner dependent on at least one of the following component fabrication parameters: specific capacitance per area of a capacitor, specific capacitance per periphery of a capacitor.

8. The method as claimed in claim 1,
wherein
the upper and lower limits of the dependent component parameter switching speed of a bipolar transistor are determined in a manner dependent on a plurality of the following component fabrication parameters: current gain of a bipolar transistor, base resistance of a bipolar transistor, saturation current of a bipolar transistor.

9. The method as claimed in claim 1,
wherein
for carrying out a normalization the upper limit of the at least one dependent component parameter is rated with +1, the lower limit of the at least one dependent component parameter is rated with −1, the upper limit of the at least one environment parameter is rated with +1 and the lower limit of the at least one environment parameter is rated with −1.

10. The method as claimed in claim 1,
wherein
the constructing of the experimental designs is effected in full-factorial or half-factorial fashion.

11. The method as claimed in claim 1,
wherein
an evaluation of interactions between at least one dependent component parameter or environment parameter and at least another dependent component parameter or environment parameter is carried out.

12. The method as claimed in claim 1,
wherein
the steps of
constructing experimental designs on the basis of rated upper and lower limits of the at least one component parameter and of the at least one environment parameter,
carrying out simulations of the experimental designs, and
analyzing the results of the simulations with regard to the influence of the at least one dependent component parameter and the at least one environment parameter are carried out for at least one of the following result variables of an operational amplifier: open loop gain, bandwidth, equivalent input noise, total distortion.

13. The method as claimed in claim 1,
wherein analyzing the results of the simulations of the experimental designs of the integrated circuit with regard to the influence of the at least one dependent component parameter and the at least one environment parameter is effected by means of Pareto methods for quantitative detection of principal effects.

14. The method as claimed in claim 1, wherein the method is carried out for designing an integrated analog circuit.
